(19) United States
(12) Patent Application Publication
(10) Pub. No.: US 2007/0210724 A1
(43) Pub. Date: Sep. 13, 2007

(54) Power adapter and DC-DC converter having acoustic transformer

(76) Inventors: Mark Unkrich, Emerald Hills, CA (US); Michael Frank, Menlo Park, CA (US); Richard C. Ruby, Menlo Park, CA (US)

Correspondence Address: Kathy Manke;Avago Technologies Limited, 4380 Ziegler Road, Fort Collins, CO, 80525, US

(21) Appl. No.: 11/440,874

(22) Filed: May 25, 2006

Related U.S. Application Data
(63) Continuation-in-part of application No. 11/371,761, filed on Mar. 9, 2006.

(51) Int. Cl. H05B 39/04; H05B 37/02

(52) U.S. Cl. 315/209 R; 315/276; 315/76

(57) ABSTRACT

An integrated power adapter, a portable electronic device with an integrated power adapter, and multichip modules are described.

### CROSS-REFERENCE TO RELATED APPLICATIONS

The present application is a continuation-in-part of and claims priority under 35 U.S.C. § 120 from commonly assigned U.S. patent application Ser. No. 11/371,761, entitled “Power Supply and Electronic Device Having Integrated Power Supply” filed Mar. 9, 2006. The present Application is related to commonly assigned U.S. patent application Ser. No. 11/371,762 entitled “AC-DC Converter Circuit and Power Supply” to Mark Unkrich and filed on Mar. 9, 2006. The disclosures of the referenced patent applications are specifically incorporated herein by reference.

### BACKGROUND

Portable electronic devices are ubiquitous in society. For example, electronic devices such as telephones, computers, radios and televisions have all evolved from stationary devices that connected to AC power in the home or office, to portable devices adapted to operate on direct current (DC) power that is normally connected directly to the device. Often, the DC power source is a battery that can be charged and recharged repeatedly for reuse. The ability to recharge the battery is both economically and environmentally beneficial.

Known methods of charging batteries of portable electronic devices include the use of a separate power adapter that is connected at one end to an alternating current (AC) power and at the other end to the battery of the portable electronic device. The power adapter converts the AC power to DC power and recharges the battery by providing DC current in a reverse direction to normal current flow of the battery.

Typically, power supplies used to provide DC power to a portable electronic device for powering the device, or charging its battery(s), or both, are separate from the device and must be carried by the user or maintained in a location for use. Moreover, known power supplies are rather bulky, often rivaling, if not exceeding the size of the portable device itself. As can be appreciated, the noted characteristics of known power supplies render them rather inconvenient to use.

Furthermore, once AC power is converted to DC power, it is often useful to convert the DC voltage to another DC voltage using a DC-DC converter. Such DC-DC converters provide secondary DC regulation. Like known power supplies, known DC-DC converters including their passive components are relatively large.

What are needed, therefore, are a power adapter and DC-DC converter that overcome at least the shortcomings of known power supplies described above.

### SUMMARY

In accordance with an illustrative embodiment, a portable electronic device includes an integrated power adapter operative to convert alternating current (AC) power to a direct current (DC) power. The integrated power adapter further includes an acoustic isolation transformer.

In accordance with another illustrative embodiment, an integrated power module includes a battery and an integrated power adapter connected to the battery and is adapted to convert alternating current (AC) voltage to a direct current (DC) voltage. The integrated power adapter also includes an acoustic isolation transformer.

In accordance with yet another illustrative embodiment an integrated power adapter includes a multi-chip module (MCM) having a substrate; an AC-DC converter and a DC-DC converter. The power adapter has components disposed in the substrate or over a surface of the substrate, or both, and is adapted to convert alternating current (AC) voltage to a direct current (DC) voltage. The power adapter also includes an acoustic transformer.

In accordance with another illustrative embodiment, a multi-chip module (MCM) includes a substrate and a DC-DC converter. The DC-DC converter has components disposed in the substrate or over a surface of the substrate, Or both. The DC-DC converter is adapted to convert an input direct current (DC) voltage into an output DC voltage. The DC-DC converter also includes an acoustic transformer.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a perspective view of a portable electronic device including an integrated power adapter in accordance with an illustrative embodiment.

FIG. 1B is a perspective view of a portable electronic device including an integrated power adapter in accordance with an illustrative embodiment.

FIG. 2 is a perspective view of a portable device including an integrated power adapter in accordance with an illustrative embodiment.

FIG. 3 is a simplified block diagram of an integrated power adapter in accordance with an illustrative embodiment.

FIG. 4 is a conceptual view of an integrated power adapter in a multi-chip module (MCM) in accordance with an illustrative embodiment.

FIG. 5 is a conceptual view of integrated power adapter in accordance with another illustrative embodiment.

FIG. 6A is a conceptual view of a DC-DC converter in accordance with an illustrative embodiment.

FIG. 6B is a conceptual view of a DC-DC converter in accordance with an illustrative embodiment.

### DEFINED TERMINOLOGY

The terms ‘a’ or ‘an’, as used herein are defined as one or more than one.

The term ‘plurality’ as used herein is defined as two or more than two.

The term ‘integrated’ is defined herein as made into a whole by bringing parts together; unified.

### DETAILED DESCRIPTION

In the following detailed description, for purposes of explanation and not limitation, specific details are set forth in order to provide a thorough understanding of illustrative embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the illustrative embodiments. Such methods and apparati are clearly within the scope of the present teachings.

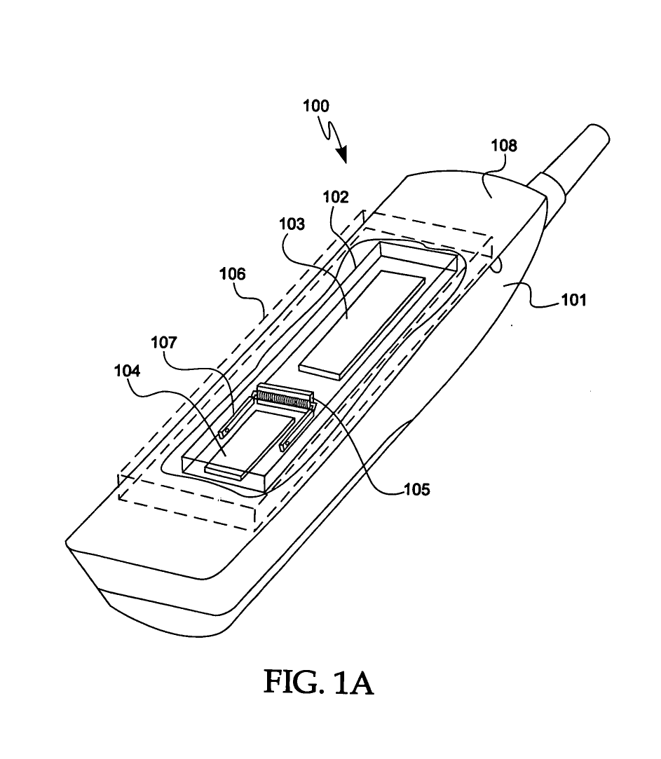

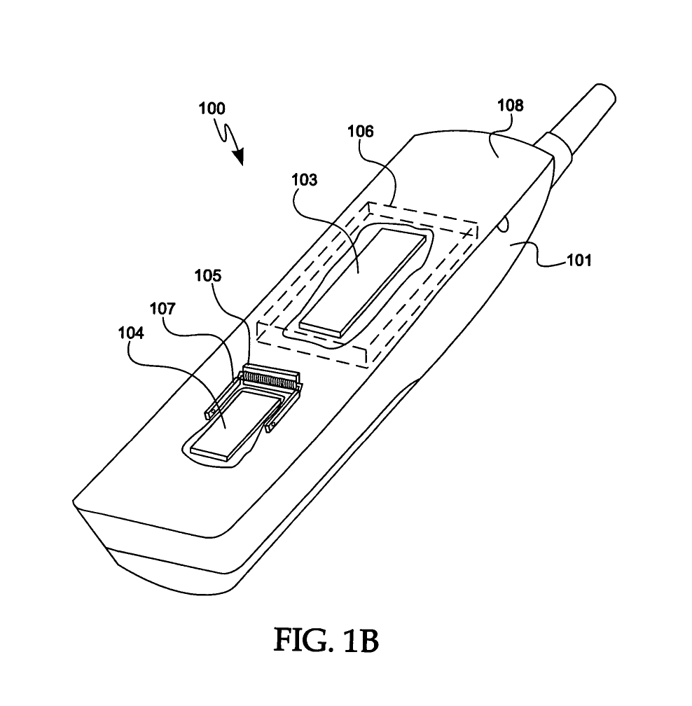

FIG. 1A is a perspective view in partial cut-away of an electronic device (device) 100 in accordance with an illustrative embodiment. In the present view, the rear or back portion of the device 100 is shown. In certain embodiments, the device 100 is a mobile device and in other embodiments, the device 100 is a stationary device. Illustratively, the device 100 may be a mobile (cellular) telephone, a personal digital assistant (PDA), a portable computer, a portable video device, a portable music device, a portable radio transceiver, a pager, a digital camera, a video recorder, or a portable global positioning system (GPS) device.

The illustrative list of types of portable electronic devices of illustrative embodiments is not intended to be in any way limiting of the application of the present teachings. Rather, the present teachings may be applied to a wide variety of electronic devices that are adapted to operate on DC power, or that includes a rechargeable battery, or both. Finally, and as will be readily apparent to one of ordinary skill in the art, many of the devices set forth in the illustrative list of devices can be incorporated into one portable electronic device. For example, the portable electronic device 100 may be a combined mobile phone, GPS device digital camera. Such portable electronic devices are contemplated by the present teachings.

The device 100 includes a housing 101 that includes germane electronic components as well as other required elements. For example, if the device 100 were a mobile phone, the housing 101 would include the transmit/receive electronics, a processor, a memory, a display and other components. As the various and sundry components required of each the illustrative devices noted above are known to those skilled in the art, details are omitted in order to avoid obscuring the description of the present embodiments.

The device 100 also includes an integrated power module 102, which is shown as a transparent component for ease of description. Integrated into the power module 102 are a battery 103 and a power adapter 104. The integrated power module 102 also includes an electrical connector 105. The needed electrical connections between the electrical connector 105, the power adapter 104 and the battery 103 are made by one or more known methods.

In certain embodiments, a charging indicator is provided. The charging indicator may be an LED disposed on the integrated power module 102, or on the device 100, or both. The charging indicator may be adapted to blink when charging is complete and to provide continuous output during charging, for example. In a specific embodiment, when the integrated power module 102 is detached from the device and connected to an AC source, the charging indicator functions to indicate charging in-progress or charging completion.

Illustratively, the integrated power module 102 is contained in the housing 101, or is disposed in a recess in the housing 101, and is enclosed by a cover 106, which connects to the housing 101. The power adapter 104, which is described more fully herein, is comparatively small and beneficially replaces known power supplies that are separate components and not integrated into the device 100.

In an illustrative embodiment, the integrated power module 102 is detachable from the device 100. In particular, the integrated power module 102 is adapted to engage electrical contacts (not shown) of the device 100 and to be affixed to the device. Once affixed, the integrated power module 102 is integrated into the device 100. Alternatively, the integrated power module 102 may not be readily detachable from the device 100. In such an embodiment, the components of the integrated power module 102 may be readily removed from the integrated power module 102 allowing for service to or replacement of the components.

In the embodiment illustrated in FIG. 1A, the integrated power module 102 is contained in the housing 101 or is disposed in a recess in the housing 101. In another embodiment, the integrated power module 102 is disposed over a back surface 108 of the device 100, with the cover 106 disposed over the integrated power supply, or the surface 108, or both. Thus, in this embodiment, the integrated power module 102 is not ‘flush’ with the back surface 108 of the device 100. The integrated power module 102 is adapted to engage the electrical contacts of the device 100 and to be affixed to the device 100.

In an embodiment, the electrical connector 105 is a prong-type connector adapted to engage a standard AC wall socket. While a two prong connector is shown, a three prong connector is contemplated. For example, the electrical connector 105 may be a two prong flat blade type connector, which is common in the United States, or a two round prong type connector common in Europe. Moreover, a known spacing-saving collapsible prong connectors are also contemplated.

The electrical connector 105 is adapted to rotate from the position shown so that in another position, prongs 107 of the connector 105 are substantially perpendicular to the back surface 108 of the device 100. In an embodiment, the cover 106 is removed providing access to the connector 105 to allow rotation of the connector 105. After being rotated into position, the prongs 107 may engage the wall outlet. This allows the front surface of the device 100, which is opposite surface 108, to be viewed. After the connection is made to the AC source, the integrated power module 102 charges the battery 103.

In an alternative embodiment, the connector 105 is accessed without removing the cover 106. Illustratively, the connector 105 would not be recessed in the housing as shown, but rather would be disposed over the surface 108. The connector 105 would then be accessed through recesses or openings in the cover 106. The connector 105 would be rotated for engaging the wall outlet as described above.

In yet another embodiment, the cover 106 is substantially flush with the surface 108. The electrical connector 105 would be accessible through the cover 106 for rotation and engagement. Notably, the cover 106 may be the cover for the rear surface 108 of the device 100. It is emphasized that the noted embodiments are merely illustrative and other embodiments in keeping with the present teachings are contemplated.

Beneficially, the integrated power module 102 of the illustrative embodiments allows for the charging of the battery 103 by the integrated power adapter 104 of the device 100 merely by plugging the connector 105 into an AC power source. As described more fully herein, the integrated power module 102 includes comparatively small components, which fosters the integration of the power module 102 into the device 100.

FIG. 1B is a perspective view in partial cut-away of the portable electronic device 100 in accordance with an illustrative embodiment. The embodiments described presently share many common features with embodiments described in connection with FIG. 1A. Such common features are generally not repeated to avoid obscuring the presently described embodiments.

In an illustrative embodiment, the power adapter 104 and the battery 103 are not an integrated component, such as integrated power module 102. However, the power adapter 104 and the electrical connector 105 are individual components integrated into the device 100. In an embodiment, the power adapter 104 is disposed in the housing 101 or is disposed in a recess in the housing 101. Likewise, the battery 103 is disposed in the housing 101, or is disposed in a recess in the housing 101. The electrical connector 105 may be provided in a recess in the housing 101 as described previously.

The cover 106 is adapted to fit over the battery 103 and may be either raised relative to or flush with the surface 108. A separate cover (not shown) may be provided over the power adapter 104, for example if the power adapter 104 were disposed in a recess and ready access to the charger was desired. Alternatively, the power adapter 104 may be accessed only by removal of the backing of the device 100.

In operation, the power adapter 104 charges the battery 103 from an AC power source, such as a wall socket. However, as will be apparent to one of ordinary skill in the art, the power adapter 104 may function to provide DC power to the device 100 from an AC source, and may be referred to herein as such. Regardless, the power adapter 104 is comparatively small in volume and is integrated into the device 100.

Beneficially, the integration of the power adapter 104 into the device 100 according to the illustrative embodiments allows the user to charge the battery 103, or operate the device 100, or both, without the need of an external battery charger.

As described more fully herein, the power adapter 104 is substantially smaller than known adapters, thereby fostering its integration with the portable electronic device 100. Nonetheless, the power adapter 104 provides comparable electrical power to that supplied by known separate or external battery chargers. Thus, the integrated power adapter 104 provides substantially the same function as known external battery chargers, but is integrated with the device 100 affording significant convenience to the user.

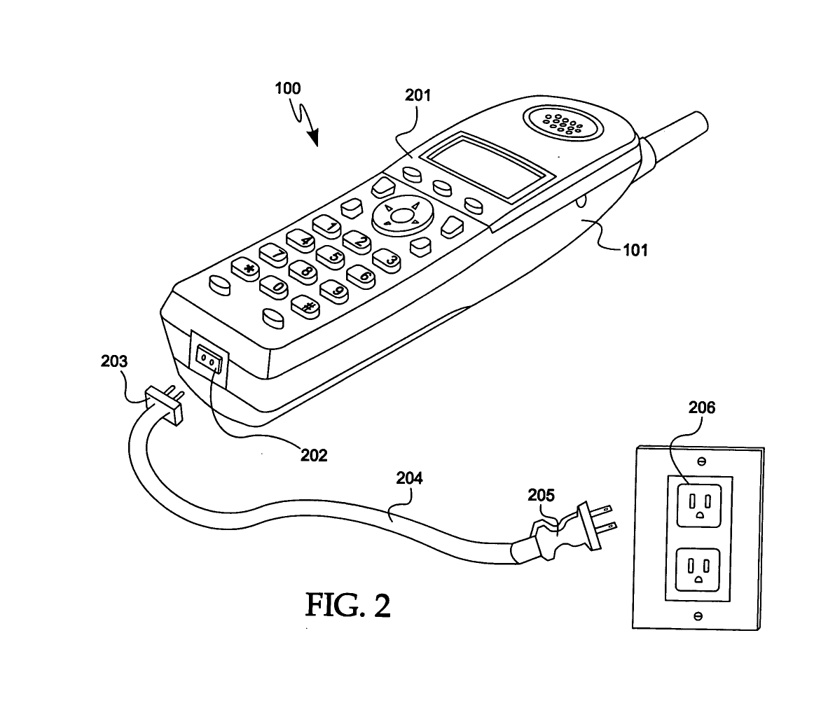

FIG. 2 is a conceptual view of the portable electronic device 100 in accordance with yet another illustrative embodiment and with a front surface 201 shown. The device 100 shares many common features with the embodiments described in connection with FIGS. 1A and 1B. The descriptions of these common features are not repeated in order to avoid obscuring the description of the present embodiment. Notably, the integrated power adapter 104, or the integrated power module 102 may be incorporated into the device 100. However, the prong-type electrical connector 105 is not necessarily included in the present embodiment.

In the embodiment shown, the device 100 is a mobile phone. It is emphasized that this is merely illustrative and that the present teachings contemplate other portable electronic devices, such those referenced previously. As is known, portable electronic devices may include one of a variety of electrical connectors that attach to an external battery charger. There are various reasons for the use of such connectors.

The present embodiment includes an electrical connector 202 that is other than a prong-type connector. The connector 202 is connected to a complementary (female or male) connector 203 that is connected to a cable 204. At the opposing end of the cable 204, a prong-style 205 connector is attached. The prong-style connector 205 engages a wall socket 206. AC power from the wall socket 206 is provided to the device 100 via the connectors 205, 203, 202. The connector 202 is connected to the power adapter 104, which charges the battery 103, or supplies DC power to the device 100, or both in a manner described in connection with the embodiments of FIGS. 1A and 1B.

In another embodiment, the use of the cable 204 is foregone. In particular, the complementary connector 203 is part of the prong-style connector 205, thus forming an adaptor. The electrical connector 202 and its complementary connector 203 may be one of a variety of electrical connectors used in portable electronic devices. The selected connectors depend on the type of device 100 and are known to those of ordinary skill in the art.

In yet another embodiment, the power adapter 104 may be integrated into the prong-style connector 205.

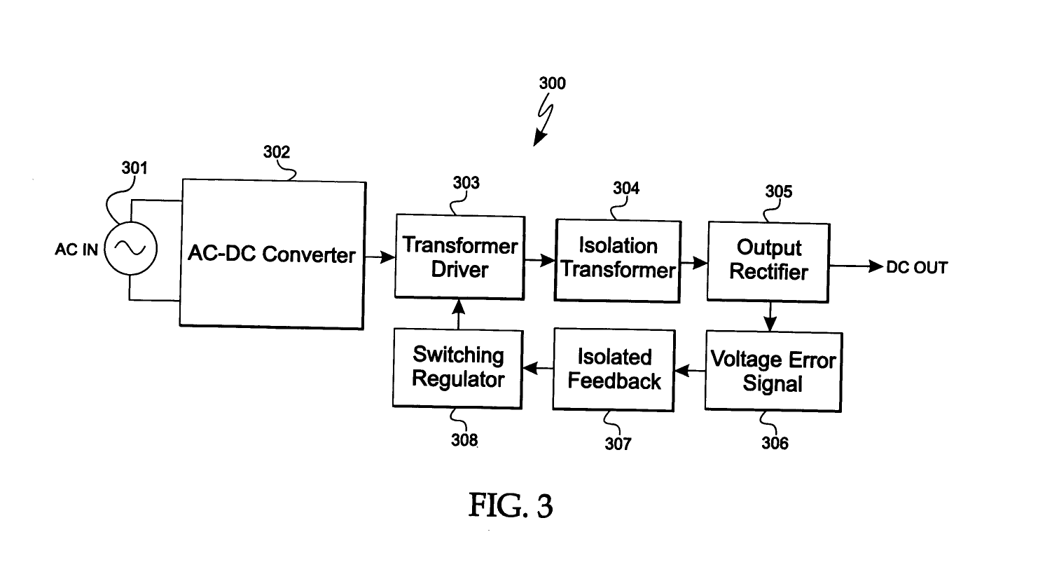

FIG. 3 is a simplified functional block diagram of a power adapter 300 in accordance with an illustrative embodiment. Notably, the power adapter 300 may be the integrated power adapter 104 described previously.

An AC power source 301 (e.g., AC power from a wall outlet) is connected to an AC-DC converter 302. The connection may be made using the connector 105, or other connectors described previously. The AC-DC converter 302 may be based on one of a variety of rectification circuit architectures. For example, the AC-DC converter 302 may include a full wave diode bridge rectifier circuit.

In an illustrative embodiment, in order to reduce the size of the capacitor holding the rectified charge following the full wave diode bridge rectifier circuit in the AC-DC converter 302 and at comparatively higher output power levels, a circuit as described in the incorporated patent application Ser. No. 11/371,762 to Unkrich may be implemented. As described more fully in the referenced application, one or more capacitors having a comparatively small capacitance are provided in the circuit. The capacitors are required to hold the charge for a relatively short period of time, thereby allowing small capacitance and therefore, dimensionally comparatively small capacitors to be used.

The output of the AC-DC converter 302 is a rectified voltage. The output voltage from the converter 302 is applied to a transformer driver 303. The transformer driver 303 may be one of a number of driver circuits, including Class E or Class F driver circuits and variations thereof, full bridge driver circuits and half-bridge driver circuits. Illustratively, the transformer driver 303 may be a surface mount packaged die.

The transformer driver 303 is connected to a switching regulator circuit 308. The transformer driver 303 typically includes one or more field effect transistor (FET) switches depending on the type of driver implemented. For example, a Class E driver typically includes one switch, a half-bridge driver includes two switches and the full-bridge circuit includes four switches for a differential input isolation transformer. The switches are turned on or off by the switching regulator circuit 308. The output of the transformer driver 303 is input to an isolation transformer 304.

Typically, the switches of the transformer driver 303 connect the inputs of the isolation transformer 304 alternately to a comparatively high DC voltage level, system ground, or open circuit depending upon the regulator architecture and transformer requirements. Moreover, the driver circuits may include components in addition to the FET switches. These components often include passive components and are used to meet certain criteria for high efficiency driving. Architectures with the drivers mentioned above may be designed to meet Zero Voltage Switching (ZVS) switching conditions, for example. The additional components for the driver circuits and architectures to meet ZVS switching conditions are known to one of ordinary skill in the art.

In illustrative embodiments, the isolation transformer 304 is an acoustic (mechanical wave) transformer that includes piezoelectric material. In certain embodiments, the isolation transformer 304 is a bulk acoustic wave transformer. The isolation transformer 304 may be an acoustically coupled transformer.

In one or more illustrative embodiments the isolation transformer 304 may be an acoustic isolation transformer, such as described in representative U.S. Pat. Nos. 6,954,121, 6,946,928, 6,927,651, 6,874,212, 6,874,211, 6,787,048, 6,668,618, 6,651,488, 6,617,249, 6,566,979, 6,550,664, 6,542,055, 6,483,229, 6,472,954, 6,469,597, 6,424,237, 6,420,820, 6,262,637, 6,215,375; and U.S. Patent Publication 2005/0128030A1 to Larson et al. Furthermore, in an embodiment, the isolation transducer 304 can include a resonant structure as described in U.S. Pat. No. 5,587,620 to Ruby, et al. The disclosures of the representative patents and patent publication are specifically incorporated herein by reference. It is emphasized that the teachings of the above-incorporated patents and publication are illustrative and that other acoustic isolation transformers are contemplated by the present teachings.

In general, the isolation transformer 304 of the representative embodiment comprises at least one primary acoustic piezoelectric transducer, an electrical isolation barrier, and at least one secondary acoustic piezoelectric transducer. In certain embodiments described herein, the acoustic transformer is not isolated. In this case the electrical isolation barrier is not required between the two acoustic piezoelectric transducers. For example, the transducers may electrically share a connection between one of the electrodes of each.

Representative piezoelectric materials include, but are not limited to, aluminum nitride (AlN), zinc oxide (ZnO) or lead zirconium titanate (PZT). Structures based on the latter are known to operate efficiently at lower frequencies.

The frequency response of the acoustic transformer is set by the velocity of sound in the materials of the transformer and the thicknesses of the materials. Depending upon the coupling mode, different dimensions are relevant. For the longitudinal mode of the acoustic transducer, the resonant frequency is a function, inter alia, of the thickness of the piezoelectric material and the thickness of metal electrodes used to drive the piezoelectric material. In a specific embodiment, the thickness of the layers of piezoelectric material and the electrodes are on the order of approximately 3.0 μm to approximately 20.0 μm. The volume of the isolation transformer 304 of a specific embodiment is in the range of approximately 1.0 mm³ to approximately 0.1 mm³.

As is known, the power per unit volume of a transformer is proportional to the resonance frequency of the transformer. Accordingly, the resonance frequency of the transformer increases with decreasing transformer size (volume or thickness in the case of the longitudinal mode resonance of the acoustic transformer) at a prescribed power level. Stated differently, by driving the isolation transformer 304 at a higher frequency, a desired output electrical power can be attained for a comparatively dimensionally smaller transformer. As such, the transformer 304 is small enough to foster integration of the power adapter 300 into a portable electronic device. By contrast, transformers of known power supplies are comparatively large.

In illustrative embodiments incorporating an acoustic transformer having dimensions described, the operational frequencies of the isolation transformer 304 are in the range of approximately 50.0 MHz to approximately 300.0 MHz with an output power of on the order of approximately 1.0 W to approximately 5.0 W. Notably, the acoustic transformer 304 may be fabricated to function at frequencies as low as approximately 10 MHz and frequencies on the order of 10⁹ Hz. It is emphasized that the noted characteristics of the isolation transformer 304 are merely illustrative. For example, the power supplies of the illustrative embodiments may be used in parallel or designed for higher or lower power output.

The output of the isolation transformer 304 is input to an output rectifier circuit 305, which provides the DC output voltage to the portable electronic device or battery, or both. The output rectifier circuit 305 may be one of a number of known circuits useful rectifying an output signal from a transformer. Beneficially, the output rectifier circuit 305 is fashioned in a dimensionally small structure or package. For example, the output rectifier circuit 305 may be a diode bridge full wave rectifier in a single die.

The power adapter 300 includes a feedback loop useful in regulating the DC output voltage. The feedback loop compares the DC output voltage with a reference voltage, which is preset or programmatically controlled to the desired output. This generates a voltage error signal that the feedback loop compensates by adjusting the modulation control generated by the switching regulator circuit 308. Commonly used modulation techniques in AC-DC power converters include frequency modulation, phase modulation and pulse width modulation. For example, there is a switching frequency at which the output voltage of the transformer is a relative maximum. Therefore adjusting the switching frequency from this level can reduce the output voltage or the power transferred through the transformer to regulate and maintain the DC output voltage.

The feedback loop is described presently. Many of the components of the loop and their function are known to one of ordinary skill in the art. As such, many details of the components are omitted in order to avoid obscuring the description of the present embodiments.

The loop includes a voltage error signal circuit 306 that taps the DC output signal from the output rectifier circuit 305. In a typical embodiment, the voltage error signal circuit 306 is a known resistor/diode circuit that may be implemented in an integrated circuit, surface mount components, packaged die or a combination thereof. Moreover, passive components may also be thin film components or thick film components that are part of a substrate of the voltage error signal circuit 306.

A voltage error signal from the circuit 306 is provided to an isolation feedback circuit 307. In a specific embodiment, the isolation feedback circuit 307 is a known optocoupler circuit that converts the input signal to an optical signal and then back to an electrical signal using photodiodes and photodetectors. In an alternative embodiment, the isolation feedback circuit 307 may be a known isolation transformer with signal modulation. For example, an acoustic isolation transformer according to the teachings of one or more of the above-incorporated patents may be used. In either embodiment, the circuit can be a packaged die and provides suitable isolation of the voltage error signal circuit from the switching regulator circuit 308.

The output of the isolation feedback circuit 307 is input to the switching regulator circuit 308. The switching regulator circuit 308 is a known control circuit that switches the transformer driver 303 rapidly typically between two states to drive power through the transformer. Modulation of the switching is part of the feedback control used to stabilize the DC output voltage from the power supply. In operation, the switching regulator circuit 308 cycles the transformer driver input between a first voltage and a second voltage to provide a desired DC output voltage.

A typical architecture for power distribution system in many devices includes an isolated power supply. For example, the isolated power supply may include the power adapter 300, which includes the AC-DC converter 302 and a DC-DC converter. In such applications, the DC-DC converter may provide a variety of output DC voltages (e.g., 5 volts and/or 12 volts or additional voltages). These output DC voltages are then distributed through the product.

As will be readily appreciated by one of ordinary skill in the art, the components of the power adapter 300 less the AC-DC converter circuit 302 comprise a DC-DC converter circuit. As such, the power adapter 300 may be described as a DC-DC converter circuit and an AC-DC converter circuit.

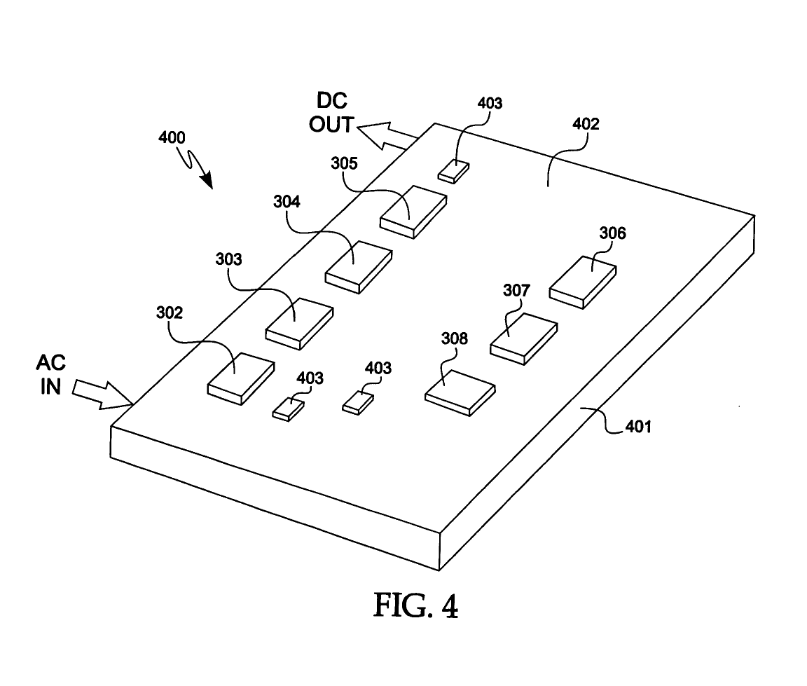

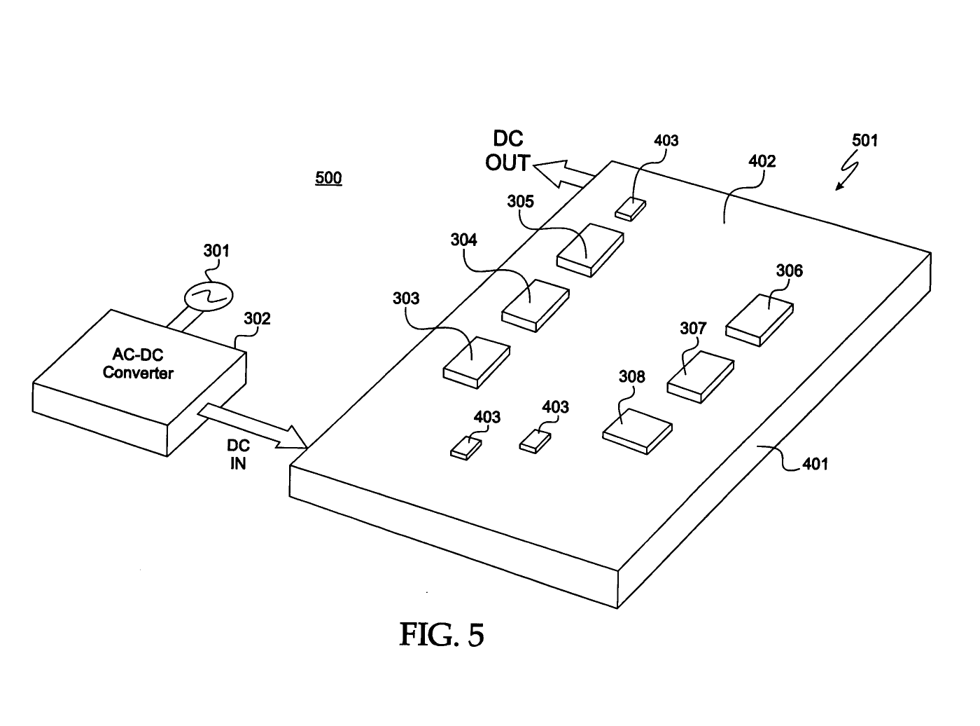

In an embodiment described in conjunction with FIG. 4, the AC-DC converter circuit and the DC-DC converter circuit are implemented on a multi-chip module (MCM). In other embodiments described in connection with FIG. 5, the DC-DC converter circuit and the AC-DC converter circuit are separate with the DC-DC converter circuit implemented on an MCM.

FIG. 4 is a conceptual view of a multi-chip module (MCM) 400 including a power adapter in accordance with an illustrative embodiment. The power adapter includes many features common to those described in connection with FIG. 3. The details of these features are not repeated so as to avoid obscuring the description of the present embodiments.

In an illustrative embodiment, the MCM 400 may include a plurality of packaged or unpackaged (bare) die disposed over a substrate 401. Additionally or alternatively, the components may include individual passive and active electrical components. These electrical components may be in ‘chip’ form. Furthermore, other circuitry such as signal conditioning circuitry (not shown), and/or supporting circuitry (not shown) may be disposed over a surface 402 of the substrate 401.

The substrate 401 may be one of a plurality of materials useful in MCM applications. These include, but are not limited to PC board (e.g., FR4) and ceramic substrates as well as others known to those skilled in the art. The substrate 401 may be processed to include connections such as circuits and vias by techniques known to those skilled in the art.

In an illustrative embodiment, the AC-DC converter 302; the transformer driver 303; the isolation transformer 304; the output rectifier circuit 305; the voltage error signal circuit 306; the isolation feedback circuit 307; and the switching regulator circuit 308 may be integrated into packaged die, or unpackaged die. In certain embodiments, the packaging may include wafer scale packaging to include microcapping of the die. As is known, microcapping can provide surface mount components and comparatively small size and low cost components.

In certain embodiments, the output rectifier circuit 305 and the voltage error signal circuit 306 are provided on the same die. In illustrative embodiments, the isolation feedback circuit 307 may be a separate die but could also be considered to be provided on or span three separate die. For example, a portion of the circuit 307 may exist on the same die as the voltage error signal circuit 306; an isolation component portion of the circuit 307 may be a separate die; and the output section of the circuit 307 may be part of the die including the switching regulator circuit 308.

In a specific embodiment, the transformer driver 303 or the isolation transformer 304, or both, may be packaged surface mount components disposed over the surface 402. In addition, passive components 403, such as used for impedance matching and signal conditioning are provided in chip form. The passive components 403 may also be embedded in or provided over the substrate 401. For example, the components 403 may be thick film or thin film components and laminate structures, to mention only a few possibilities. The passive components 403 include, for example, chip resistors, chip inductors and chip capacitors. In yet another embodiment, the substrate and the components that comprise the power adapter 300 may be overmolded, for example, over the surface 402 of the substrate 401.

The input AC signal is provided to the MCM 400 via contacts (not shown). Circuit traces (not shown) are fabricated by standard methods and provide the connections to and from the components of the MCM 400. Ultimately, the MCM 400 provides an output DC voltage.

In embodiments, isolation is achieved by maintaining physical separation between the “input” side and the “output” sides of the circuit. For example, AC-DC converter 302; the transformer driver 303; and the switching regulator circuit 308 are on one side and the output rectifier circuit 305 and the voltage error signal circuit 306 are on the other side. These components, circuit traces, and power and ground leads are respectively isolated for these two circuits as separate “halves” or regions of the substrate 401 in a corresponding fashion. The interconnect or interface between these two sections is comprised of the isolation transformer 304 and the isolation feedback circuit 307. As is known, these components have internal isolation. Similarly, the mounting and device connections, respectively, connect to the corresponding isolated input and output portions of the AC-DC power converter.

The MCM 400 beneficially provides a circuit that is small compared to current discrete circuit implementations. Illustratively, the battery 103 may be disposed over the substrate 401 to provide the power module 102 described in connection with FIG. 1A. Alternatively, the MCM 400 may be integrated into a package that includes the battery 103. In yet another embodiment, the MCM 400 provides the power adapter 104 described in connection with FIG. 1B. As will be readily appreciated, the MCM 400 fosters integration of the power adapter 104 into a portable electronic device according to the present teachings. In another embodiment, the inclusion of signal conditioning components such as a capacitor or inductor or combination of both is contemplated. These components may be useful for energy storage and filtering. Illustratively, the additional capacitor may not be part of the MCM 400 but able to connect to it and be incorporated in the module 102 or device 100. The additional capacitor may be beneficial in certain higher power applications.

FIG. 5 is a conceptual view of a power adapter 500 in accordance with an illustrative embodiment. The power adapter 500 includes many features common to those described in connection with FIGS. 3 and 4. The details of these features are not repeated so as to avoid obscuring the description of the present embodiments.

The power adapter 500 includes an MCM 501 and the AC-DC converter 302, which is separate from the MCM 501. The MCM 501 comprises a DC-DC converter circuit. In an illustrative embodiment, the DC-DC converter circuit includes: the transformer driver 303; the isolation transformer circuit 304; the output rectifier circuit 305; the voltage error signal circuit 306; the isolated feedback circuit 307; the switching regulator circuit 308; and passive components 403.

The AC-DC converter 302 converts an input AC signal from the AC source 301 to a DC signal, which is input to the MCM 501. In the present embodiment, the DC input signal is provided to the DC-DC converter circuit including the transformer driver 303 via connections on the MCM 501, and the power conversion occurs as described in connection with FIGS. 3 and 4. The DC-DC converter circuit then provides the DC output signal.

In accordance with illustrative embodiments, the components of the power adapter 500 are provided as packaged or unpackaged die on the MCM 501. Additionally or alternatively, the components may include individual passive and active electrical components. In an embodiment, the power adapter has components disposed in the substrate or over the surface 402 of the substrate 401, or both. Furthermore, other circuitry such as signal conditioning circuitry (not shown), and/or supporting circuitry (not shown) may be disposed over the surface 402 of the substrate 401.

In certain embodiments, the DC-DC converter circuit of the MCM 501 converts an input DC voltage from a higher voltage to a lower voltage (down-converter); and in other embodiments, MCM 501 converts an input DC voltage from a lower voltage to a higher voltage (up-converter). Moreover, according to an illustrative embodiment, the DC-DC converter circuit is isolated by maintaining physical separation between the input side and the output side of the circuit, much in the same manner that the power adapter of the illustrative embodiment of FIG. 4 is isolated.

As will be appreciated, in certain applications isolation at the DC-DC converter is not needed. Accordingly, in certain illustrative embodiments measures to achieve isolation may be foregone. As such, certain alternative embodiments are contemplated. For example, the acoustic transformer 304 is not necessarily an isolated acoustic transformer; although it certainly can be an isolated acoustic transformer.

In certain embodiments in which the DC-DC converter is not isolated, the output rectifier circuit 305 may be combined (e.g., on a common die) with the voltage error signal circuit 306. In addition, the transformer driver 303 may be integrated with the switching regulator circuit 308, although an output switch (not shown) is often a separate die.

Moreover, in an embodiment the individual die, or components, or both, of the transformer driver 303; the output rectifier circuit 305; the voltage error signal circuit 306; and the switching regulator circuit 308 may be integrated into a single die comprising the components of each. As such, the MCM 501 may comprise a single die, the acoustic transformer 304 and passive components 403.

In an illustrative embodiment, the AC-DC converter 302 is implemented in a circuit comprising, inter alia, resistors, diodes, capacitors, inductors, and fuses. Alternatively, the AC-DC converter 302 is implemented with components mounted on the substrate 401 or as a packaged module that connects to the MCM 501 by one or more known electrical connections. For example, the AC-DC converter 302 and the MCM 501 may be mounted on a common printed circuit board (not shown) and connected by traces on the board. Alternatively, the AC-DC converter 302 may be connected by a ribbon cable connection, wires, or similar connection.

In a specific embodiment, once the connections are made, the power adapter 500 may be integrated into a portable electronic device such as device 100 described previously, or into the prong-style connector 205. Alternatively, the MCM 501 may be integrated into the device 100 and the connections to the AC-DC converter 302 made thereafter. In another specific embodiment, the AC-DC converter 302 may be disconnected from the MCM 501 and the converter 302, or the MCM 501, or both, and may be removed from the device 101. Regardless, the power adapter 500 may be integrated into the portable electronic device 100 or the prong-style connector.

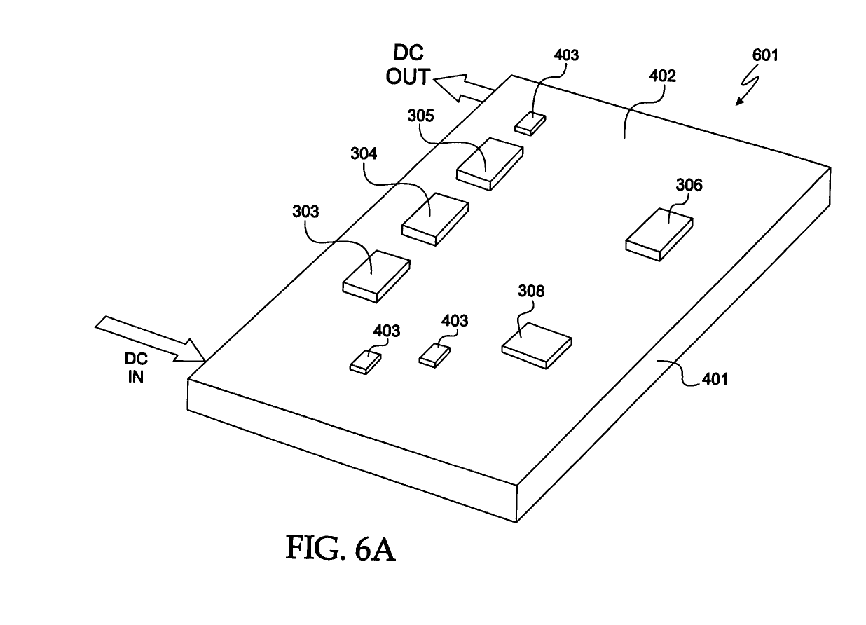

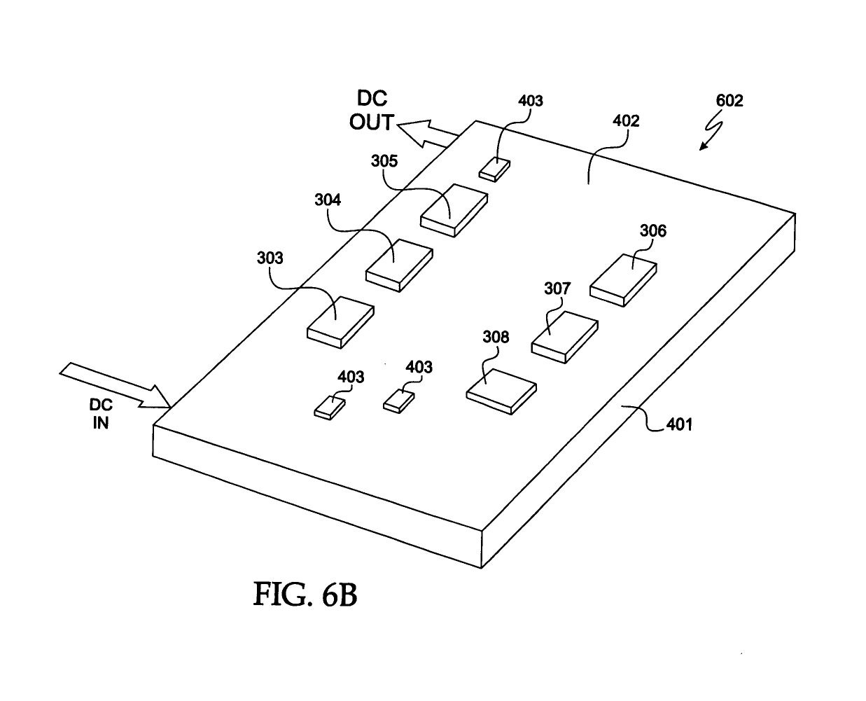

In accordance with illustrative embodiments, a second level of DC-DC conversion is provided at the point where the specific voltage is required in the overall system. This second level of regulation is often referred to as a “point of load” regulation. For example, it may be necessary to then step down a 5.0 volt DC supply further to 1.8 volts. Such embodiments are described presently. In embodiments described in connection with FIG. 6A, the DC-DC converter is not isolated; and in embodiments described in connection with FIG. 6B, the DC-DC converter is isolated.

FIG. 6A is a conceptual view of a DC-DC converter circuit implemented on an MCM 601 in accordance with an illustrative embodiment. The MCM 601 includes many features common to those described in connection with FIGS. 3, 4 and 5. The details of these features are not repeated so as to avoid obscuring the description of the present embodiments.

In accordance with illustrative embodiments, the components of the MCM 601 are provided as packaged or unpackaged die on the MCM 601. Additionally or alternatively, the components of the MCM 601 may include individual passive and active electrical components. These electrical components may be in ‘chip’ form. Furthermore, other circuitry such as signal conditioning circuitry (not shown), and/or supporting circuitry (not shown) may be disposed over the substrate 401.

In the present embodiment, the DC input to the MCM 601 is received from a power source (not shown) such as a power supply that provides AC/DC conversion and regulation of an input AC signal, a battery, or other power source. Illustratively, the DC input signal to the MCM 601 of FIG. 6A may be the DC output signal from the MCM 501 of FIG. 5. Beneficially, the power source is electrically isolated. As such, electrical isolation at the DC-DC converter of the MCM 601 is not necessary.

The DC output of the power source is provided as the DC input to the MCM 601 for regulation and up conversion or down conversion of the voltage by the DC-DC converter. Accordingly, the AC-DC converter 302 is not provided on the MCM 601. Furthermore, in embodiments in which the DC-DC converter is not isolated there is no need for the isolation feedback circuit 307.

The DC-DC converter circuit of the MCM 601 includes: the transformer driver 303; the acoustic transformer 304; the output rectifier circuit 305; the voltage error signal circuit 306; the switching regulator circuit 308; and passive elements 403. In an embodiment, the DC-DC converter has components disposed in the substrate 401 or over the surface 402 of the substrate 401, or both,

The DC input signal is provided to the DC-DC converter including the transformer driver 303 via connections on the MCM 601, and AC-DC power conversion occurs as described in connection with FIGS. 3-5. The DC-DC converter circuit then provides the DC output signal. Thus, the DC-DC converter functions as a point-of-load regulator.

In the present embodiment, because isolation at the DC-DC converter is not essential, certain alternative embodiments are contemplated. For example, the acoustic transformer 304 is not necessarily an isolated acoustic transformer; although it certainly can be an isolated acoustic transformer. Furthermore, because isolation is not necessary at the DC-DC converter, the voltage error signal circuit 306 and the switching regulator circuit 308 do not need to be integrated into separate die. Thus, a single die comprising the components of the voltage error signal circuit 306 and the switching regulator circuit 308 may replace the individual die shown.

Furthermore, in an embodiment the individual circuits of the transformer driver 303; the output rectifier circuit 305; the voltage error signal circuit 306; and the switching regulator circuit 308 may be integrated into a single die comprising the components of each. As such, the MCM 601 may comprise a single die, the acoustic transformer 304 and passive components 403. Furthermore, in an embodiment, the acoustic transformer 304 may be integrated together with the single die on the same substrate.

FIG. 6B is a conceptual view of a DC-DC converter circuit implemented on an MCM 602 in accordance with another illustrative embodiment. The MCM 602 includes many features common to those described in connection with FIGS. 3-6A. The details of these features are not repeated so as to avoid obscuring the description of the present embodiments.

Like the DC-DC converter of FIG. 6A, the DC-DC converter of the MCM 602 is a point-of-load regulator. The DC input may be from an isolated power source (not shown) as described previously. Nonetheless, the DC-DC converter of the present embodiment is isolated. In particular, the DC-DC converter includes the transformer driver 303; the acoustic isolation transformer 304; the output rectifier circuit 305; the voltage error signal circuit 306; the feedback isolation circuit 307; the switching regulator circuit 308; and passive elements 403. The function of these components is described herein and is thus not repeated.

In accordance with illustrative embodiments, an integrated power adapter, a portable electronic device including an integrated power adapter, and an integrated DC-DC converter are described. Beneficially, the power adapter and the DC-DC converter include components that are comparatively small in dimension but provide the requisite electrical performance by virtue of present teachings. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. A portable electronic device, comprising:
an integrated power adapter operative to convert alternating current (AC) power to a direct current (DC) power, the integrated power adapter further comprising:
an acoustic isolation transformer.

2. A portable electronic device as recited in claim 1, wherein the acoustic isolation transformer includes a bulk acoustic resonator.

3. A portable electronic device as recited in claim 1, wherein the acoustic isolation transformer includes a stack of film piezoelectric material.

4. A portable electronic device as recited in claim 1, wherein the portable electronic device includes one or more of a mobile telephone; a personal digital assistant (PDA); a portable computer; a portable video device; a portable music device; a portable radio transceiver; a pager; or a digital camera; or a video recorder; or a portable global positioning system (GPS) device.

5. A portable electronic device as recited in claim 2, wherein the acoustic transformer further comprises lead zirconium titanate (PZT) piezoelectric material, or aluminum nitride (AlN) piezoelectric material, or zinc oxide (ZnO) piezoelectric material.

6. A portable electronic device as recited in claim 1, further comprising an integrated electrical connector adapted to connect the integrated power adapter to the AC power source.

7. A portable electronic device as recited in claim 6, wherein the integrated electrical connector is a prong connector adapted to connect to a wall outlet.

8. A portable electronic device as recited in claim 6, wherein the integrated electrical connector is adapted to connect to a complementary connector, which is connected to a prong connector adapted to connect to a wall outlet.

9. A portable electronic device as recited in claim 1, further comprising an integrated power module, which comprises the integrated power adapter and a battery.

10. A portable electronic device as recited in claim 1, wherein the power adapter is a multi-chip module.

11. A portable electronic device as recited in claim 9, wherein the integrated power adapter is a multichip module.

12. An integrated power module, comprising:
a battery;
an integrated power adapter connected to the battery and adapted to convert alternating current (AC) voltage to a direct current (DC) voltage, the integrated power adapter further comprising:
an acoustic isolation transformer.

13. An integrated power module as recited in claim 12, wherein the acoustic isolation transformer includes a bulk acoustic resonator.

14. An integrated power module as recited in claim 12, wherein the acoustic isolation transformer includes a stack of film piezoelectric material.

15. An integrated power module as recited in claim 12, further comprising a charging indicator.

16. An integrated power module as recited in claim 12, further comprising an integrated electrical connector adapted to connect the integrated battery charger to the AC source.

17. An integrated power module as recited in claim 12, wherein the integrated electrical connector is a prong connector adapted to connect to a wall outlet.

18. An integrated power module as recited in claim 12, wherein the power adapter is a multi-chip module (MCM).

19. An integrated power module as recited in claim 12, wherein the acoustic transformer further comprises lead zirconium titanate (PZT) piezoelectric material, or aluminum nitride (AlN) piezoelectric material, or zinc oxide (ZnO) piezoelectric material.

20. An integrated power adapter, comprising:
a multi-chip module (MCM) having a substrate;
an AC-DC converter;
a DC-DC converter, the power adapter having components disposed in the substrate or over a surface of the substrate, or both, and being adapted to convert alternating current (AC) voltage to a direct current (DC) voltage, the power adapter further comprising:
an acoustic transformer.

21. An integrated power adapter as recited in claim 20, wherein the acoustic transformer includes a bulk acoustic resonator.

22. An integrated power adapter as recited in claim 20, wherein the acoustic transformer includes a stack of piezoelectric material.

23. An integrated power adapter as recited in claim 20, wherein the acoustic transformer is an acoustic isolation transformer.

24. An integrated power adapter as recited in claim 20, wherein the acoustic transformer further comprises lead zirconium titanate (PZT) piezoelectric material, or aluminum nitride (AlN) piezoelectric material, or zinc oxide (ZnO) piezoelectric material.

25. An integrated power adapter as recited in claim 20, wherein the AC-DC converter is disposed over the substrate.

26. An integrated power adapter as recited in claim 20, wherein the AC-DC converter is separate from and electrically connected to the MCM.

27. An integrated power adapter as recited in claim 20, wherein the DC-DC converter comprises components disposed in the substrate or over a surface of the substrate, or both.

28. An integrated power adapter as recited in claim 20, wherein the DC-DC converter circuit is an isolated DC-DC converter circuit.

29. An integrated power adapter as recited in claim 20, wherein the DC-DC converter circuit is not an isolated DC-DC converter circuit.

30. An integrated power adapter as recited in claim 20, wherein the DC-DC converter circuit further comprises: a transformer driver; an output rectifier circuit; a voltage error signal circuit; and a switching regulator circuit.

31. An integrated power adapter as recited in claim 29, wherein the voltage error signal circuit and the switching regulator circuit are implemented in a common die.

32. An integrated power adapter as recited in claim 29, wherein the transformer driver; the output rectifier circuit; the voltage error signal circuit; and the switching regulator circuit are implemented in a common die.

33. A multi-chip module (MCM), comprising:
a substrate; and
a DC-DC converter having components disposed in the substrate or over a surface of the substrate, or both, and adapted to convert an input direct current (DC) voltage into an output DC voltage, the DC-DC converter further comprising:
an acoustic transformer.

34. An MCM as recited in claim 33, wherein the acoustic transformer includes a bulk acoustic resonator.

35. An MCM as recited in claim 33, wherein the acoustic transformer includes a stack of piezoelectric material.

36. An MCM as recited in claim 33, wherein the acoustic transformer is an acoustic isolation transformer.

37. An MCM as recited in claim 33, wherein the acoustic transformer further comprises lead zirconium titanate (PZT) piezoelectric material, or aluminum nitride (AlN) piezoelectric material, or zinc oxide (ZnO) piezoelectric material.

38. An MCM as recited in claim 33, wherein the DC-DC converter is an isolated DC-DC converter.

39. An MCM as recited in claim 33, wherein the DC-DC converter is not an isolated DC-DC converter.

40. An MCM as recited in claim 33, wherein the DC-DC converter further comprises: a transformer driver; an output rectifier; a voltage error signal circuit; and a switching regulator circuit.

41. An MCM as recited in claim 39, wherein the DC-DC converter further comprises: a transformer driver; an output rectifier; a voltage error signal circuit; and a switching regulator circuit.

42. An MCM as recited in claim 41, wherein the voltage error signal circuit and the switching regulator circuit are implemented in a common die.

43. An MCM as recited in claim 41, wherein the transformer driver, the output rectifier circuit, the voltage error signal circuit, and the switching regulator circuit are implemented in a common die.
